(19) United States
(12) Patent Application Publication
(10) Pub. No.: US 2010/0146007 A1
(43) Pub. Date: Jun. 10, 2010

(54) Database For Managing Repertory Grids

(76) Inventor: Alex Kononov, Brussels (BE)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/331,410

(22) Filed: Dec. 9, 2008

(51) Int. Cl. G06F 7/06; G06F 17/30

(52) U.S. Cl. 707/802; 707/E17.014; 707/E17.044; 707/758

(57) ABSTRACT

The subject matter disclosed herein provides methods and apparatus, including computer program products, for generating a data structure, such as a sparse matrix for storing repertory grids, and for searching the data structure. In one aspect there is provided a method. The method may include generating a data structure comprising elements, constructs, and rates. The constructs represent characteristics of the elements. The rates represent the relevance of the constructs with respect to the elements. At least one of the rates represent that a construct is not relevant to an element. The method may also include searching the generated data structure. Related systems, apparatus, methods, and/or articles are also described.

### FIELD

This disclosure relates to capturing, storing, and retrieving expert knowledge.

### BACKGROUND

In 1955, an interviewing technique called repertory grid was published by George Kelly. The interview technique involves a psychologist and a subject. The psychologist suggests a topic, like the automobile industry, for example. The subject is then asked to produce a list of examples or instances of the topic, called elements, such as automobiles. In this example, the list of elements provided by the subject might include the following: Mercedes, BMW, Ford, Ferrari, and Chrysler. Next, the psychologist takes a triad of three elements at random (e.g., Mercedes, BMW, and Ford) and asks the subject to provide a trait that is common to two of the elements, but not the third element. This trait, called a construct, is expressed as a contrast. For example, the subject may decide that Mercedes and BMW are European cars, while Ford is an American car. The psychologist records this relationship as a construct, which refers to the traits “is a European car” and “is an American car.” This repertory interview process is repeated with different triads of elements until the subject can no longer produce any constructs. For example, the subject may provide the following constructs for the automobile elements listed above: “is a European car” or “is an American car”; “is fast” or “is slow”; “is expensive” or “is cheap”; and “is reliable” or “breaks often”; and so forth.

The psychologist then asks the subject to rank all elements (e.g., Mercedes, BMW, Ford, Ferrari, and Chrysler) against every construct by creating a rating. The rating can be binary (e.g., Chrysler is an American car or is not an American car) or scaled (e.g., Ferrari is very fast, BMW is fast, and Ford is slow). These results are recorded in a grid, referred to as a repertory grid, which includes the elements, constructs, and ratings. The repertory grid and the above noted interview process has been used quite widely in business, marketing, training, education, and human resources.

### SUMMARY

The subject matter disclosed herein provides methods and apparatus, including computer program products, for generating a data structure, such as a repertory grid, and for searching the data structure.

In one aspect there is provided a method. The method may include generating a data structure comprising elements, constructs, and rates. The constructs represent characteristics of the elements. The rates represent the relevance of the constructs with respect to the elements. At least one of the rates represent that a construct is not relevant to an element. The method may also include searching the generated data structure.

Articles are also described that comprise a tangibly embodied machine-readable medium embodying instructions that, when performed, cause one or more machines (e.g., computers, etc.) to result in operations described herein. Similarly, computer systems are also described that may include a processor and a memory coupled to the processor. The memory may include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWING

These and other aspects will now be described in detail with reference to the following drawings.

FIG. 1 illustrates a system 100 for generating data structures and searching the generated data structures;

FIG. 2A depicts a process for generating data structures and searching the generated data structures;

FIG. 2B depicts a process for searching using a relevance measurement;

FIGS. 3A-B, 4A-C, and 5-13 depicts pages presented at a user interface as part of the processes of FIGS. 2A and 2B; and

FIG. 14 depicts a process for gathering data to generate a data structure.

Like reference symbols in the various drawings indicate like elements.

### DETAILED DESCRIPTION

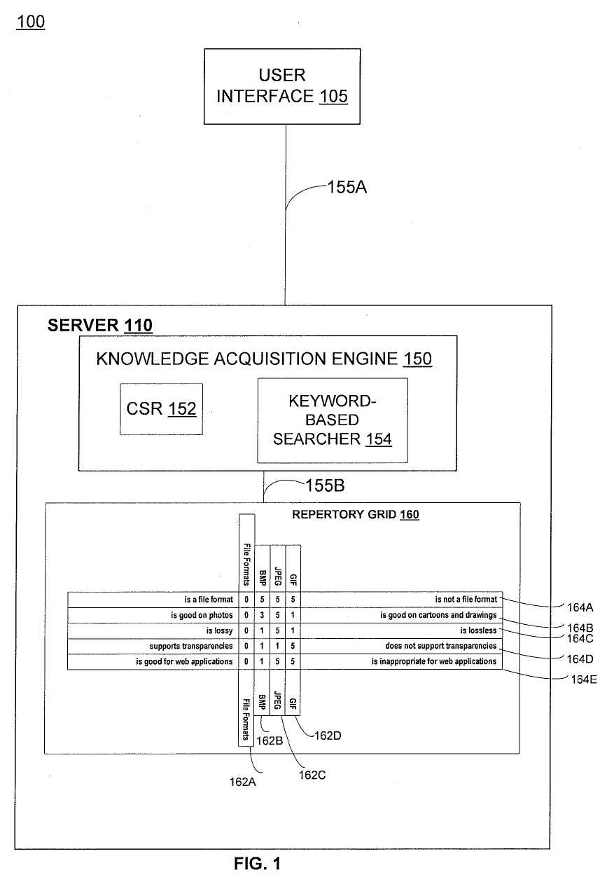

FIG. 1 depicts a system 100 for generating a data structure that can be searched. System 100 includes a user interface 105 and a server 110, which are coupled by communication link 155A. Server 110 further includes a knowledge acquisition engine 150, a data structure, such as a repertory grid 160, and a criteria-based searcher with ranking (labelled CSR 152), and a keyword-based searcher 154, all of which are described further below. The knowledge acquisition engine 150 may be coupled to the repertory grid 160 via communication link 155B. Although FIG. 1 depicts repertory grid 160 located at the same server 110 as knowledge acquisition engine 150, repertory grid 160 may be located at other locations as well (e.g., at a database separate from server 110).

Unlike past repertory grids, the repertory grid 160 is configured to allow elements from different domains. Returning to the previous car example, the elements and constructs may all relate to cars, but if an airplane element (which is from another domain) is added, the constructs appropriate for the airplane domain may not be appropriate for automobiles. For example, the construct “has a ceiling above 30,000 feet” is not relevant to the cars domain. In this example, a single data structure, such as repertory grid 160, is able to handle elements from different domains using a rating for a construct that has a predetermined value, such as a value of zero, a blank value in the grid, or any other predetermined value representing that the rating is not relevant to the element. As such, repertory grid 160, unlike past approaches, is configured to include elements from different domains. The domain may thus refer to a subset of information, such as an area of knowledge (e.g., computers, transportation, file formats, types of automobiles, and the like) or an area of activity (e.g., debugging, code development, and the like).

Although the description herein refers to repertory grid 160, the repertory grid 160 may be configured as any other data structure including a matrix, a sparse matrix, and an array. Moreover, the data structure may be implemented in a database or any other persistency mechanism.

In some implementations, the system 100 searches using a keyword-based search (which is performed by keyword-based searcher 154), a criteria-based search (which is performed by CSR 152), or a combination of the two. The keyword-based searcher 154 and CSR 152 (both of which are described further below) may be used to search a data structure, such as repertory grid 160, which may be gathered during a repertory interview process.

The repertory grid 160 includes elements, constructs, and ratings. As noted above, repertory grid 160 may include one or more ratings. Moreover, one or more of the ratings may have a predetermined value, such as a value of zero, a blank value in the grid, or any other predetermined value, to represent that an element is not relevant to (i.e., not to be rated by) a given construct—providing thus a more robust repertory grid 160 configured to allow elements from different domains and allow constructs that are not relevant to all elements. Moreover, the use of this predetermined value may enable a larger repertory grid 160 with a larger number of elements (e.g., millions of elements or more), when compared to past repertory grids which were limited to, for example, a few tens of elements from a single domain.

User interface 105 may be implemented as any type of interface mechanism for a user, such as a Web browser, a client, a smart client, a mobile wireless device (e.g., a personal digital assistant, a phone, and the like), and any other presentation and/or interface mechanism. For example, the user interface 105 may be implemented as a processor (e.g., a computer) including a Web browser to provide access to the Internet (e.g., via using communication link 155A) to interface to (and/or access) server 110.

Communication links 155A-B may be any type of communications mechanism and may include, alone or in any suitable combination, the Internet, a telephony-based network, a local area network (LAN), a wide area network (WAN), a dedicated intranet, wireless LAN, an intranet, a wireless network, a bus, or any other communication mechanisms. Further, any suitable combination of wired and/or wireless components and systems may provide communication link 155A-B. Moreover, communication link 155A-B may be embodied using bidirectional, unidirectional, or dedicated networks. Communications through communication link 155A-B may also operate with standard transmission protocols, such as Transmission Control Protocol/Internet Protocol (TCP/IP), Hyper Text Transfer Protocol (HTTP), SOAP, RPC, or other protocols. In some implementations, communication link 155A-B is the Internet (also referred to as the Web).

Server 110 may be implemented as a processor (e.g., a computer, a blade, and the like). Server 110 may further include a knowledge acquisition engine 150 configured to generate a data structure, such as repertory grid 160. In some implementation, the knowledge acquisition engine 150 generates the repertory grid 160 by receiving information from, for example, user interface 105. The received information may be obtained during a repertory interview process (e.g., using so-called triads of elements, and asking users to provide constructs, and ratings). Moreover, the received information may be configured into the repertory grid 160 and may include elements, constructs, and rates, all of which are further described below. In some implementations, the data of the repertory grid 160 is persisted in a database, which may be coupled to server 110 via the communication link 155B.

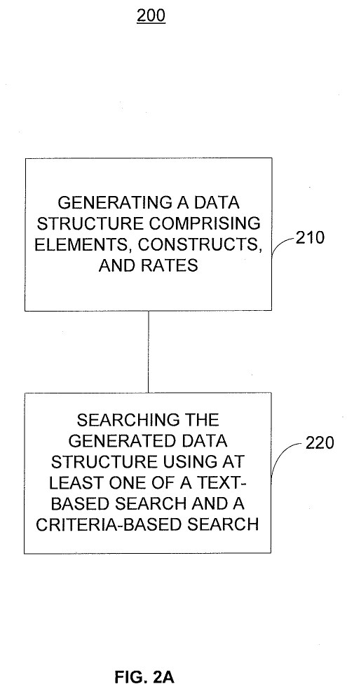

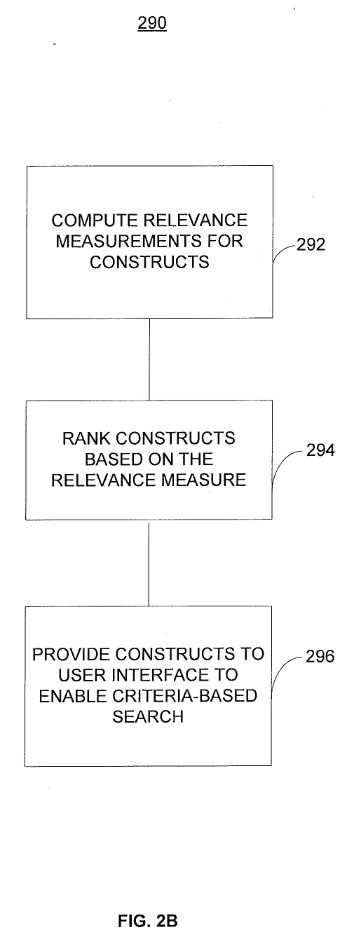

FIG. 2 depicts a process 200 for using system 100 to generate and/or search a data structure, such as the repertory grid 160. In some implementations, the system 100 and process 200 are used in connection with a repertory interview process (for data capture), although system 100 and process 200 may be used in other environments and data capture processes as well. The description of process 200 at FIG. 2 also refers to FIG. 1.

At 210, a data structure is generated. For example, knowledge acquisition engine 150 may generate a data structure, such the repertory grid 160, although other data structure may be used as well. Moreover, the repertory grid 160 may include elements, constructs, and rates, all of which are described further below.

System 200 may implement 210 as part of a data capture phase in which a user provides information via user interface 105 to knowledge acquisition engine 150 during a repertory interview process, and that information is configured into repertory grid 160. For example, the repertory interview may be used to receive information obtained from a user by generating pages (e.g., hypertext markup language (HTML) pages presented at user interface 105) configured to solicit elements, constructs, and rates (which includes the predetermined value feature described above (e.g., a zero rate value and the like to represent an element that is not relevant given a construct)) via that repertory interview process. The received information is captured and stored as the repertory grid 160. When system 100 performs 210, the data gathering used to generate the data structure is often referred to as the interview (or repertory interview) phase.

At 220, the data structure (e.g., the repertory grid 160) is searched using a keyword-based search, a criteria-based search, or a combination of the two. For example, knowledge acquisition engine 150 may receive from user interface 105 a query value for searching the repertory grid 160. This search may be implemented as a keyword-based search (e.g., by keyword-based searcher 154) and/or a criteria-based search (e.g., by CSR 152). Moreover, the search(es) may be performed iteratively until a result is obtained. Moreover, the results of a search may be used as input into another search. When system 100 performs 220, this is often referred to as a consultation phase, which refers to a user identifying an answer to a question using queries of the repertory grid 160, which includes so-called “expert knowledge” obtained during the repertory interview process described above with respect to 210.

Although any type of search mechanism may be used to search repertory grid 160, CSR 152 may search the data of repertory grid 160 using a criteria-based search with a relevance ranking (which is described further below). Criteria-based search may provide an extremely effective tool to a user, when the user lacks sufficient knowledge to perform a keyword-based search. For example, a user at user interface 105 may not know “what to looking for,” or “what it is called,” but the user may know “what it should do” or “what it is like.” In this case, a keyword-based search may not yield useful results because the user lacks sufficient knowledge to provide keyword search terms (e.g., domain-specific terms, like “plutonic leucocratic rocks”) to accurately describe the item being searched. However, criteria-based search builds questions from constructs to force a user to adapt his or her search terminology to terms defined by a so-called “expert” during the repertory interview phase. In short, the criteria-based search uses the expert's knowledge (which is used to form the elements, constructs, and rates) to guide a user of user interface 105 through a search of elements (e.g., an index of the elements).

In some implementations, system 100 may be configured to work “side-by-side” with a user, such as an expert. In this case, system 100 may capture data (and updates to that data) during a repertory interview processes used to generate a data structure at 210. Moreover, system 100 may be consulted by a user (regardless of whether the user is an expert or not) during the consultation phase 220 to search repertory grid 160.

Table 1 below is a reproduction of repertory grid 160. The repertory grid includes elements,.such as file formats, GIF, JPEG, and BMP. In this example, the elements GIF, JPEG, and BMP are child elements of the parent element file formats (e.g., the child elements are a subset of file formats). Moreover, the constructs at Table 1 include the following contrasts: is a file format—is not a file format, is good on photos—is not good on photos, is lossy—is lossless, supports transparencies—does not support transparencies, and is good for web applications—is inappropriate for web applications. The rates are the values represented by the values 0, 1, 3, 5. In this example, a rating with a zero value represents that a construct is not relevant to an element. For example, the construct “is good on photos” is not relevant to the given element “file format.” However, the construct “is good on photos” is relevant to GIF, JPEG, and BMP elements. Moreover, the rating value of 5 represents one extreme (e.g., is a file format, is good with photos, is lossy, supports transparencies, and is good for web applications), and a value of 1 represents that the other extreme (e.g., “is not a file format,” “is not good with photos,” “is good with cartoons and drawings,” “is lossless,” “does not support transparencies,” and “is not good for web applications”). The ratings value 3 characterizes an element as being in the middle, between the two extremes of a construct (e.g., neither good with photos nor good with cartoons and drawings). Table 1 is only exemplary as other elements, constructs, and ratings may be included in repertory grid.

TABLE 1
EXAMPLE OF A REPERTORY GRID

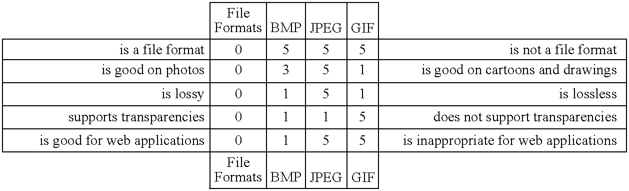

Table 2 is similar to Table 1, but Table 2 has been augmented with additional elements (e.g., MP3, MID, AU, and WAV) from different domains. For example, unlike GIF, JPEG, and BMP, which are image file formats, MP3 is an audio file format. As such, the rating for MP3 is zero (0) for the construct “is good on photos” since whether the MP3 audio file is good with photos is not a relevant trait of the MP3 element.

TABLE 2
ANOTHER EXAMPLE OF A REPERTORY GRID

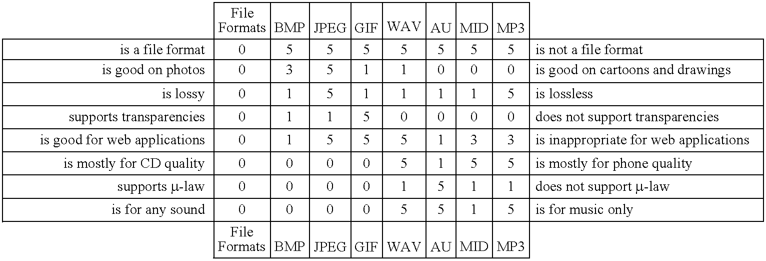

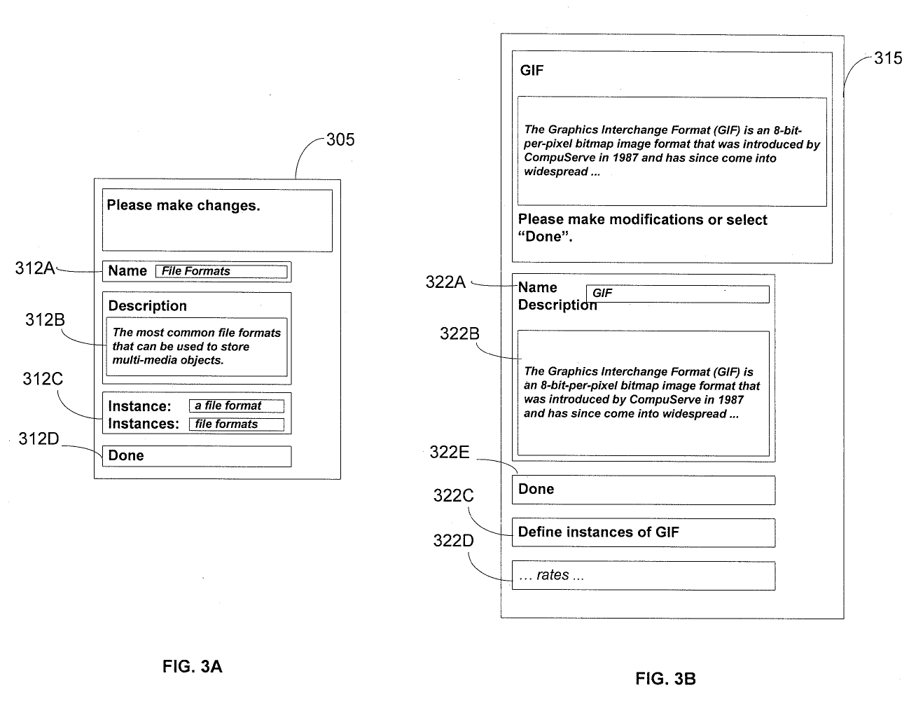

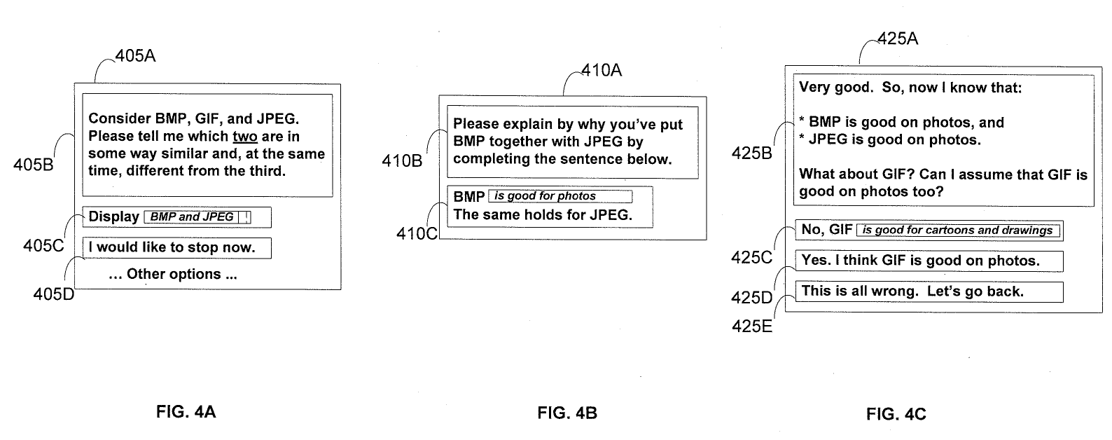

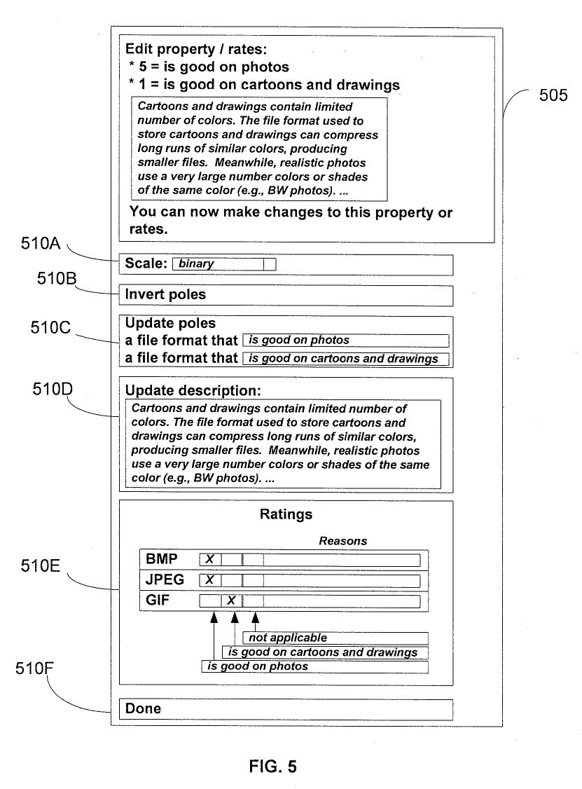

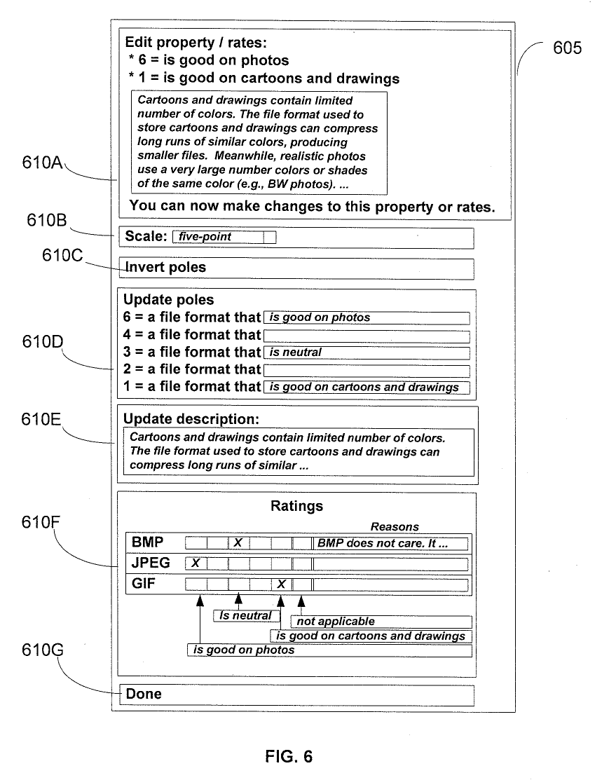

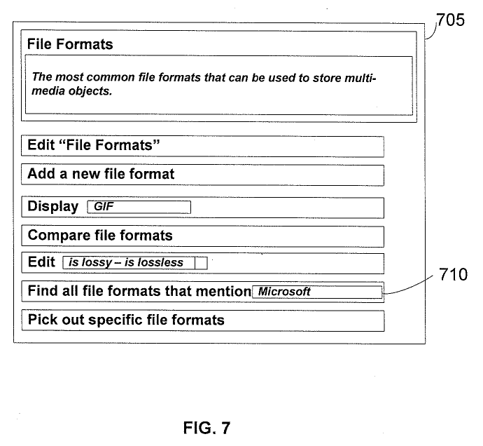

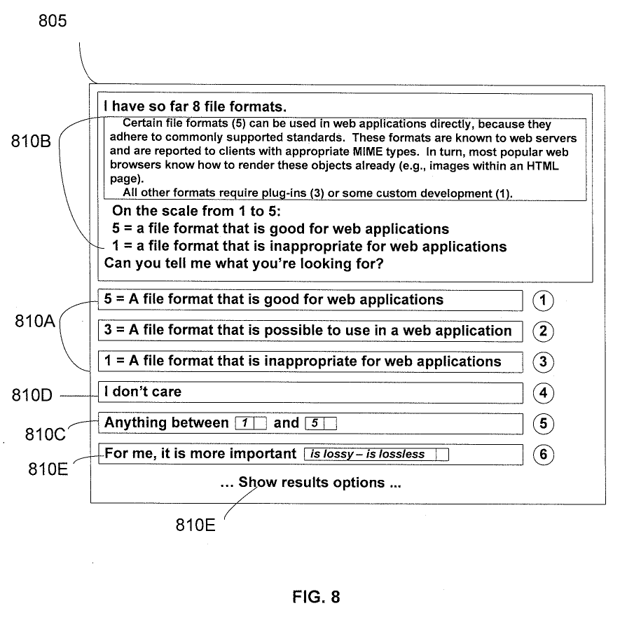

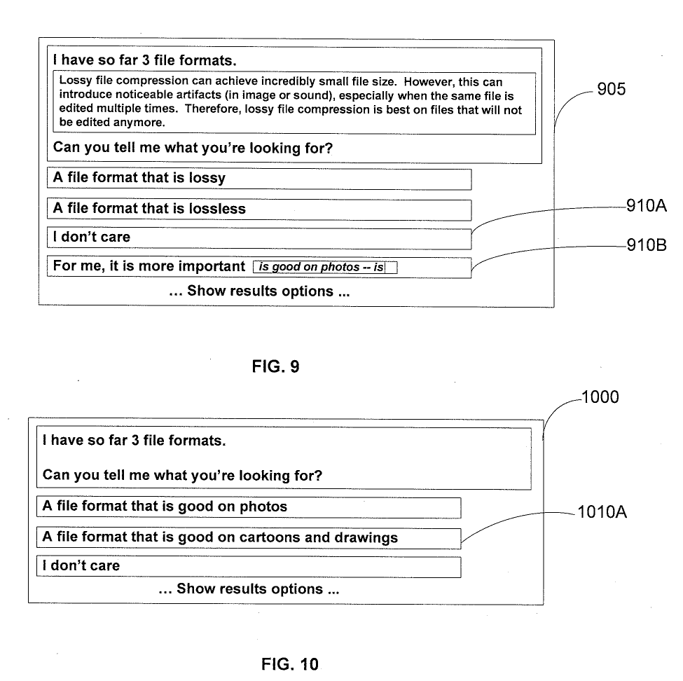

In some implementations, the data included in repertory grid 160 is determined during the repertory interview, which is guided by knowledge acquisition engine 150. For example, knowledge acquisition engine 150 may generate pages (e.g., HTML pages) for presentation at user interface 105 (which is further described below with respect to FIGS. 3A-B, 4A-C, and 5-13). These pages may enable a user at user interface 105 to provide information, such as elements, constructs, and rates, during the repertory interview to knowledge acquisition engine 150, resulting in the addition and characterization of the elements, constructs, and rates.

In some implementations, the elements 162A-D are configured to include one or more of the following attributes (which are stored-at repertory grid 160): a name, a description, and an instance. The name refers to a unique identifier, such as a tag (or identifier) of characters (e.g., JPEG 162C). A description (which may be searched at 220) refers to a full description of the element. For example, a simple textual description for an element named “TIFF” may be as follows:
Tagged Image File Format (abbreviated TIFF) is a file format for storing images, including photographs and line art. It is now under the control of Adobe Systems. Originally created by the company Aldus for use with what was then called desktop publishing, the TIFF format is widely supported.
   Instance refers to whether the element is a single item or a plurality of items. For example, the element named file format 162A may have instances file format and file formats.

Elements, which correspond to the columns of the repertory grid 160, may typically include descriptive attributes, as depicted at Table 3 below. These attributes may include a unique identifier (labeled Element_ID), a name (labeled Element_Name), and a full description of the element (labeled Element_Desc). The full description of the element may be a static textual description, a dynamic piece of code, or a combination of both. For example, HTML is used for this purpose, which can include static HTML supplied by the server 110, dynamic HTML produced by code running on the server 110, and/or applets running on a client, such as user interface 110 (or a computer hosting user interface 105).

TABLE 3
EXAMPLE OF ELEMENTS

| Element_ID | Element_Name | Element_Desc |
|---|---|---|
| E20-GIF | GIF | The Graphics Interchange Format (GIF) |
| | | is an 8-bit-per-pixel bitmap image |
| | | format that was introduced by |
| | | CompuServe in 1987 and has since |
| | | come into widespread usage on the |
| | | World Wide Web due to its wide |
| | | support and portability. |
| E32-JPEG | JPEG | JPEG (pronounced JAY-peg; IPA: is a |
| | | commonly used method of compression |
| | | for photographic images. The name |
| | | JPEG stands for Joint Photographic |
| | | Experts Group, the name of the com- |
| | | mittee that created the standard. The |
| | | group was organized in 1986, issuing a |
| | | standard in 1992, which was approved |
| | | in 1994 as ISO 10918-1. JPEG is |
| | | distinct from MPEG (Moving Picture |
| | | Experts Group), which produces com- |
| | | pression schemes for video. |
| E11-BMP | BMP | The BMP file format, sometimes called |
| | | bitmap or DIB file format (for device- |
| | | independent bitmap), is an image file |
| | | format used to store bitmap digital |
| | | images, especially on Microsoft |
| | | Windows and OS/2 operating systems. |

Moreover, constructs may be configured to include one or more of the following attributes: (which are stored at repertory grid 160): main poles, a construct type, intermediate values, and a description. Main poles refer to the two extremes of the construct (e.g., “is fast” and “is slow”). The construct type refers to whether the construct is binary, a 5-point, and any other range of constructs. A binary construct has a range of two values, such as is fast or is slow. A 5-point construct means that the construct has a range of 5 values, such as 2 extreme values (e.g., is slow and is fast) and 3 intermediate values. Although the previous example uses a 5-point construct type, other point values (e.g., 3-point, 4-point, and so forth) may be used as well. The intermediate values may also be defined as part of the construct (e.g., “is not too fast,” “is average speed,” and “tends to be slow”). The description field of the construct may describe the construct. The construct description as well as the element description may be in a similar format (e.g., text, an HTML page, a PDF document, etc.) and may be searched at 220.

Constructs 164A-E thus represent a trait of an element, which can be represented as a contrast. That is, it is typically not sufficient to indicate a single trait, like “is good,” for example, because “is good versus is poor” is distinct from the constructs “is good versus is evil.” Moreover, constructs typically include basic terms that can be used to make sense of the elements. For the topic of image file formats, for example, constructs may include “is good on photos—is good on cartoons and drawings,” “is lossless—is lossy”, “supports transparencies—does not support transparencies,” and so forth. The two opposing contrasts (e.g., extreme positions on a scale) are stored as poles, as depicted in Table 4 below. Table 4 depicts attributes of a construct, such as construct identifiers (labeled “Construct_ID”), a construct type (labeled “Construct Type”), a minimum construct (labeled “Construct Min”), and the opposite construct (labeled “Construct_Max”).

TABLE 4
EXAMPLE OF CONSTRUCTS

| Construct_ID | Construct_Type | Construct_Min | Construct_Max |
|---|---|---|---|
| C20-P-D | 5 | is for photos | is for cartoons and |
| | | | drawings |
| C10-L-NL | 2 | is lossless | is lossy |
| C30-T-NT | 2 | supports | does not support |
| | | transparencies | transparencies |

Moreover, in some implementations, a construct C may have two poles, such as “is X” and “is Y.” In all scales (i.e., the range of values of the ratings), the minimum score of 1 places an element E next to one of the poles, such as “E is X.” Meanwhile, the maximum score (i.e., 2 for binary, 3 for 3-point, 5 for 5-point, etc.) places the element E next to the other pole (e.g., “E is Y”). To avoid the confusion, system 100 may normalize all scales, such that 1 means one pole and some other number, say N, means the other pole, regardless of the scale used to rate an element. The choice of N uses, for example, the maximum score in the scale with the maximum resolution. Thus, if we have 5-point scale as the maximum resolution scale, the binary scores allowed become 1 and 5. Notice that 5 now means exactly same thing, regardless if an element was rated on a binary or a 5-point scale. For example, if the maximum resolution is 101-point scale of ratings (e.g., for percentages), binary ratings (i.e., scores) will be 1 and 101, while 5-point scores will be 1, 26, 51, 76, and 101. That is, in general, for any choice of N and a given R-point scale where R<N, the following equation may be used:

$$n score on R \text{-} point scale = 1 + \frac{n - 1}{R - 1} \times ( N - 1 ) , \qquad Equation 1$$

wherein N is the maximum resolution used within the system 100 (e.g., this may represent the maximum resolution for any construct known to the system 100 or, alternatively, the maximum resolution the system 100 would allow any new construct to be defined at), R is the resolution of a given construct (e.g., R must always be less or equal to N), and n is the rate of an element on a given construct on the R-point scale (e.g., n is between 1 and R). The result of Equation 1 is what the rate of this element should be on the N-point scale (between 1 and N now).

A rate essentially ties an element to a construct by scoring the element on the construct. For example, the rate may have a value between 1-5 in a 5-point scheme or a value of 1 or 5 in a binary scheme. In any case, the rate may be determined during the data gathering phase 210 (e.g., during a repertory interview).

The rate may have a corresponding set of attributes, which includes, for example, a value, such as the score determined during the data gathering phase of the repertory interview, and an optional textual explanation of the rate. For any scale, a rating (or score) of a zero, which in this example represents that the element is not relevant to the construct. Therefore, a scale should not use zero for a valid, relevant score and should start with a non-zero value instead. For example, the ratings for a binary ratings may scale correspond to the scores 1 and 2, for a 3-point, the ratings may correspond to scores 1, 2, and 3, and so forth, with a predetermined value (e.g., a zero value, a blank value, etc.) reserved for the non-relevant elements for a given construct.

The rate thus refers to a value indicating how a given element is rated against a given construct. In some implementations, the rates may also have a corresponding set of attributes. These attributes include a location within the grid 160 (e.g., Element_ID and Construct_ID identifying a cell within the grid 160), a rate value (e.g., Rate_Value), and a rate reason (labeled Rate_Reason) to describe why a given element obtained a particular rate against a given construct). Table 5 below depicts an example of rates and their attributes.

TABLE 5
EXAMPLE OF RATES

| Element_ID | Construct_ID | Rate_Value | Rate_Reason |
|---|---|---|---|
| E11-BMP | C10-L-NL | 5 | |
| E11-BMP | C20-P-D | 3 | JPEG is better then |
| | | | BMP on photos |
| E11-BMP | C30-T-NT | 5 | |
| E32-JPEG | C10-L-NL | 1 | |
| E32-JPEG | C20-P-D | 5 | |
| E32-JPEG | C30-T-NT | 5 | |
| E20-GIF | C10-L-NL | 5 | |
| E20-GIF | C20-P-D | 1 | |
| E20-GIF | C30-T-NT | 1 | |

As noted, when a rating has a value of zero (or, e.g., a blank value and the like) for a given element, this zero value represents that the element is not relevant to a given construct. For example, the element Toyota may have a zero rating value against the construct “can fly above 30,000 feet” since this construct is not relevant to the element Toyota, which in this example is a carmaker. Although the description herein uses the example of 1-5 and 0, other value schemes (e.g., numeric, character-based, alpha numeric, and the like) may be used as well. The rate may also have an associated reason to describe, for example, why a particular rate was assigned to a given element. This description may be formatted as text, an HTML page, a PDF document, and the like and searched at 220.

In some implementations, the use of the above-noted zero rating is a feature of system 100. Specifically, the repertory grid 160 configured with zero rating values (or, e.g., blank values or other like predetermined values) allows elements from one domain to coexist with elements from another domain, as not all elements need to be rated against all possible constructs of the repertory grid 160. In this sense, some constructs may span elements from different domains. For example, given elements JPEG, GIF, BMP, and MS Word, all of which are file formats, the elements JPEG, GIF, and BMP are image file formats, so a construct such as “is good with photos” is relevant (e.g., can be valued with a value between 1 and 5 using a 5-point approach). However, the element MS Word is a text file format, so the construct “is good with photos” is irrelevant (e.g., is valued with a zero (0) or is left blank in the repertory grid 160). Continuing with this example, a fifth element named Lamborghini may be added. In this example, the file related constructs, which were relevant to JPEG, GIF, BMP, and MS Word, are not likely to be relevant to Lamborghini, so these file related constructs would most likely be rated as a zero against the Lamborghini.

During the consultation phase of 220, a user starts with elements of repertory grid 160 stored, for example, in a database. A user at user interface 105 may perform one or more searches of repertory grid 160 to reduce the set of elements in a result set. The result set initially includes all the elements being searched in the repertory grid, and as one or more searches are performed on the repertory grid 160, the result set typically includes a subset of those elements. Moreover, these searches may be executed until only a single element is found or the user decides to stop searching. The results set is typically presented as a page at user interface 105. The page is typically generated by knowledge acquisition engine 150 (or keyword-based searcher 154 or CSR 152) and provided to user interface 105 for presentation.

As noted above, the search of repertory grid 160 may be a keyword-based search or a criteria-based search. For the keyword-based search, the user enters at user interface 105 text, such as a word or a phrase. Keyword-based searcher 154 uses the text to query the repertory grid 160. The keyword-based searcher 154 may query any aspect of repertory grid 160 for the keyword (e.g., match the keyword to elements, constructs, and/or ratings). Any aspect of the repertory grid 160, which results in a match (e.g., find elements that include a keyword “X” or find elements that do not include the keyword “X”), is isolated, becoming candidates for presentation at user interface 105 and/or the subject of a subsequent search. If no elements are matched, keyword-based searcher 154 may generate an error, which is provided (e.g., sent) to the user interface 105 for presentation.

The search of repertory grid 160 may include a criteria-based search performed by CSR 152. Generally, the criteria-based search is used to figure out what a user at user interface 105 wants by asking one or more questions (e.g., do you want a fast element, do you want a slow element, do you want an element that is good with pictures, do you want an element that is good with cartoons, you don't care, and so forth.) The criteria-based search is based on constructs used to qualify elements found in a result set generated by searching repertory grid 160.

Although any type of search algorithm may be used by knowledge acquisition engine 150, in some implementations, CSR 152 provides a criteria-based search with ranking based on a relevance measurement (which is described below) to divide the elements of repertory grid 160 into groups (e.g., groups of approximately equal size). For example, in the case of a bipolar construct type, CSR 152 searches grid 160 to reduce the number of resulting elements in the result set by half, and in the case of a 5-point construct type to reduce the number of resulting elements to ⅓rd, ¼th, or even ⅕th. However, when CSR 152 isolates the group of elements in the result set, CSR 152 may re-compute the ranking (e.g., based on a relevance measure) of the constructs because what was once a less relevant construct may become more relevant within a smaller group of elements of the result set. CSR 152 typically minimizes the number of questions that will need to be asked during the criteria-based search by asking the most important question (as measured by the relevance measure) one at a time to divide the result set of elements into smaller and smaller groups until a search result is identified.

In some implementations, CSR 152 implements the following process to perform a criteria-based search of repertory grid 160.

Suppose, the set S={e₁, e₂, . . . , e_{N}} represents the elements included in repertory grid 160, where eᵢ is an element for 1≦i≦N. The set of elements S is a result set of elements, which include one or more elements of repertory grid 160 (e.g., before any searches are performed of grid 160, S may include all of the elements, but as CSR 152 performs criteria-based searches, the quantity of elements in S decreases).

Next, CSR 152 finds a set C={c₁, c₂, . . . , c_{M}}, where cⱼ is a construct for 1≦j≦M, and r_{i,j} represents the rate (eᵢ, cⱼ)>0. That is, all constructs, for which there is at least one element in S that has the rate as zero (or any other mark, indicating “not relevant”), are discarded, so C contains only constructs that produce non-zero (“relevant”) rates on all elements of the current S (S can be different at every iteration, becoming smaller and smaller).

In some implementations, CSR 152 may also discard all constructs from the set C that were previously presented to the user at user interface 105. For example, if the construct “is lossy” or “is lossless” was already used to reduce a result set S, then that construct would be discarded the set C (e.g., discarded from Table 2 resulting in Table 6 below). If there are no constructs C remaining, then CSR 152 stops at that point as the constructs cannot discriminate between the elements in the set of elements S.

Next, for every construct j in the set of constructs C, CSR 152 computes a relevance measurement (e.g., a statistic) across the ratings of a construct. The relevance measurement for a given construct C reflects (e.g., is proportional to) the variability in rates associated with C across all elements under consideration (e.g., all elements in the grid 160 (or, e.g., a sparse matrix, and the like) or a subset S isolated so far). For example, if there is little variability in the ratings of a given construct, then a criteria-based search using that construct is not likely to lead to a reduced result set of elements. However, if there is a large amount variability in the ratings of a given construct, then a criteria-based search using that construct is likely to lead to a reduced result set of elements.

For example, for every construct j in the set of constructs C and a possible (non-zero) rate value k (e.g., for every cⱼεC and 1≦k≦5), CSR 152 computes a relevance measurement (or statistic) across the 5-points ratings, where k varies from 1 to 5. The 5-points correspond to the five possible values a rating for a construct may have. In this example, CSR 152 may use the following equation to count the number of elements that are rated at 1 (collected in set P_{j,1}), then number of elements that are rated at 2 (collected in set P_{j,2}), an so forth to 5 (in P_{j,5}):

P_{j,k}={e_{q}|1≦q≦N and r_{k,j}=k} Equation 2,

CSR 152 then normalizes five counters (i.e., P_{j,1} through P_{j,5}) by dividing each count by the total number of elements involved, |S|, producing V_{j,k}, so that V_{j,k} is normalized between zero and one. In some implementations, CSR 152 performs this normalization based on the following equation:

V_{j,k}=|P_{j,k}|/|S| Equation 3,

In some implementations, CSR 152 uses the following equation to determine the similarity measurement for the construct j:

$$Sim ( {c}_{j} ) = \frac{{\sum }_{k = 1}^{5} ( {V}_{j , k}^{2} ) - \frac{1}{5} \times {\sum }_{k = 1}^{5} {V}_{j , k} \times {\sum }_{k = 1}^{5} {V}_{j , k}}{4} , \qquad Equation 4$$

wherein Sim(cⱼ) is the similarity measurement for a given construct j against all elements in the current set S.

Although the above example uses a 5-point example, other ranges of ratings may be used as well. Moreover, the resolution, R, may be normalized to a given value, as described above with respect to Equation 1. When Equation 1 is used to normalize the resolution of the ratings (also referred to as the scale), Equation 4 above has the following form:

$$Sim ( {c}_{j} ) = \frac{{\sum }_{k = 1}^{R} ( {V}_{j , k}^{2} ) - \frac{1}{R} \times {\sum }_{k = 1}^{R} {V}_{j , k} \times {\sum }_{k = 1}^{R} {V}_{j , k}}{R - 1} . \qquad Equation 5$$

The similarity measurement Sim(cⱼ) may have one or more of the following characteristics. First, if for a given construct, cⱼ, Sim(cⱼ) is equal to a predetermined threshold value, then all elements in the set S are rated the same against this construct. For example, if we have instances of the same element that are all rated 5 for the construct “is an image file format,” the similarity measure would be equal to the predetermined threshold value (which in this 5-point example, corresponds to 0.2, or, in general, for a R-point scale, corresponds to 1/R). In this example, the construct would not discriminate the elements of the result set, and thus not reduce the quantity of elements in the result set. Second, similarity measures smaller than the predetermined threshold value may indicate that elements in S are rated differently against this construct. Moreover, the smaller the similarity measure is, the higher the variability is of the ratings, the larger is relevance, which is optimum. In other words, relevance of a given construct cⱼ to the current set of elements S is measured as the inverse of the similarity measure Sim(cⱼ). In this example, the construct would discriminate the elements of the result set, and thus reduce the quantity of elements in the result set. The value of 0.2 is given as an example based on a 5-point construct type, although other values may be used as well when different resolution scales are employed.

After the similarity measurements are determined, CSR 152 sorts all constructs C according to the similarity measurement Sim(cⱼ). For example, CSR 152 sorts all constructs C using similarity measurement Sim(cⱼ), such that the first construct in the list has the smallest similarity measurement Sim(cⱼ) (i.e., largest relevance) and the last construct in the list has the largest similarity measurement (i.e., least relevant), producing a list of constructs L. CSR 152 then selects the first construct c_{d} from the sorted list L, which has the smallest similarity measurement Sim(cⱼ), or, the highest relevance, which corresponds to the highest degree of discrimination of the elements.

In implementations using Equation 4 above, CSR 152 may stop processing when the relevance measurement has a predetermined value indicative that the elements are all rated the same. For example, in a 5-point rating system, a relevance measure equal to a threshold value of 0.2 may mean that there is no construct in C that can discriminate between elements in S because all constructs in C are rated the same.

CSR 152 generates a page, which is sent to user interface 105 for presentation. The generated page may include the sorted constructs (according to the similarity measure Sim(cⱼ)), a description of the most relevant construct (first one in the list or selected by the user), and a field to allow the user to input a specific rate. For example, the user may select a construct based on the relevance measure determined above at Equation 4. Moreover, the user may input a specific rate, such as a single value X between 1 and 5 or a range of values. The value(s) provided by the user are sent to CSR 152. CSR 152 then selects one or more elements from the current set of elements S that satisfy the rate and construct to form a new result set, which may be used as the new above-described result set S. The new result set can be processed using keyword-based search, criteria-based search, and/or the criteria-based search with ranking, as described above with respect to CSR 152.

For example, a user may decide either to enter a rate for the system suggested construct C1 and keep searching or instead to ignore the rate question for C1 and select another construct C2 instead. In the latter case, the process is repeated, so the system generates description of the construct C2 and asks for the rate for the construct C2.

In some other implementations, CSR 152 implements the following process to perform a criteria-based search of repertory grid 160. The criteria-based search process for a 5-point scale resolution is described below.

First, CSR 152 defines set O (e.g., O={o₁, o₂, . . . , o_{R}}) as the set of all constructs that were already processed by the system during the current search. Initially, O is an empty set. The CSR 152 also defines a set S (e.g., S={e₁, e₂, . . . , e_{N}}) as the set of N elements found via a search thus far. Initially, S includes all elements in the repertory grid 160, which may be implemented as a grid 160 or a sparse matrix as noted above. Next, the set of all constructs C (e.g., C={c₁, c₂, . . . , c_{M}}) are defined. Next, CSR 152 selects A={a₁, a₂, . . . , a_{P}} to be the set of all currently applicable constructs, i.e., aᵢεC and aᵢ∉O, 1≦i≦P, and rate(eₖ,aᵢ)>0 for all eₖεS, 1≦k≦N. In other words, A is a subset of C, containing only constructs, which have non-zero rates on all elements of S that the CSR 152 did not process yet. In Table 6 below, for example, only the first construct (is lossless—is lossy) would qualify because all other constructs have a zero value for some elements.

TABLE 6
EXAMPLE REPORTORY GRID

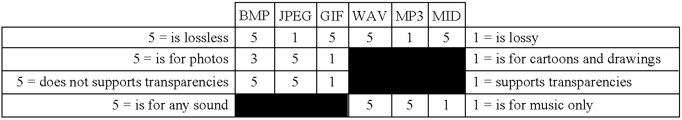

If A is a null set (e.g. . . . , with no more constructs), the search is terminated with the result set S. Otherwise, CSR 152 computes the similarity scores sᵢ for every aᵢεA (1≦i≦P) as follows. For a construct aᵢεA and 1≦j≦5, let rⱼ be the number of elements eₖεS, 1≦k≦N that have rate(aᵢ, eₖ)=j. For example, say on some construct aᵢ there are 10 elements scored at 1, 2, 1, 5, 5, 2, 3, 1, 1, and 5, respectively. Then r₁=4, r₂=2, r₃=1, r₄=0, and r₅=3. Then, the similarity is sᵢ=max(r₁, r₂, r₃, r₄, r₅)/N. In this example the maximum is r₁=4, so the similarity is 4. Next, from each similarity score sᵢ, a relevance measure dᵢ is obtained, where for any sᵢ, dᵢ=1−sᵢ.

Next, the set A is sorted according to the relevance measure obtained, producing an ordered list QA=<qa₁, qa₂, . . . , qa_{P}> of all constructs aᵢεA, with the corresponding relevance scores QD=<qd₁, qd₂, . . . , qd_{P}>, where any qdᵢ, 1≦i≦P, is the relevance for qaᵢ, and in a decreasing order. That is, qdᵢ≧qdⱼ whenever i<j, which means that qd₁ is the largest and qd_{P} is the smallest.

The largest relevance score, qd₁, is examined. If qd₁=0, then all elements in S have identical rates against all constructs in A. In this case, the criteria-based search is terminated with the result set S because there is no construct left that can discern any difference between elements in S.

Otherwise, the CSR 152 formulates a question (e.g., generates a page for presentation at user interface 105) to the user based on the corresponding construct, qa₁. The user is presented with the possibility of contrasting poles and, if available, intermediate values. For example, using the second construct from Table 6, the CSR 152 may ask: “Are you looking for an image file format that is good on photos, an image file format that is good on cartoons and drawings, or somewhere in between?” The user answers at user interface 105 the question either with a fixed allowed value or by specifying a range (e.g., a min and a max). The former is equivalent to a range (e.g., where a minimum is equal to a maximum is equal to a fixed rate). A user can also reply at user interface 105 with “I don't care,” which becomes equivalent to a range with a minimum equal to 1 and maximum equal to 5.

The CSR 152 examines all elements eₖεS, 1≦k≦N, removing all elements that do not match user's criterion. For this, CSR 152 ensures that min≦rate(qa₁,eₖ)≦max, that is, within the range specified by the user.

If the resulting set S has no elements, an exception is reported back to the user interface 105, the set S is restored to its previous state, and processing resumes with formulating a question as described above.

If there is only one element left in S (e.g., N=1), the criteria-based search is terminated, with the result set S containing this one element. Otherwise, there is more than one element. Then, the above-described process is repeated staring with defining the sets O, S, and C, as described above, where qa₁ is added to set O.

When a criteria-based search stops because there are no more constructs in C, there can still be many elements left. In this case, the user can issue a keyword-based search to reduce the number of elements. Then, new constructs can emerge, allowing another search, such as another criteria-based search. This process may be repeated until a search result is identified.

FIG. 2B describes a process 290 for ranking constructs using a relevance measure. The description of FIG. 2B also refers to FIG. 1.

At 292, a relevance measure is calculated based on the variability of the ratings across elements against a given construct. For example, CSR 152 may determine the relevance measurement using Equation 4 described above.

At 294, the constructs are ranked based on the determined relevance measurements. For example, CSR 152 may rank the constructs based on the values determined using Equation 4. Moreover, the ranking may include sorting the constructs, so that the so-called “top construct” (which is most relevant and thus discriminates the elements the most) is listed first on a list of constructs.

At 296, the constructs are then provided to the user interface to enable a search, such as a criteria-based search. For example, CSR 152 may provide the sorted list of constructs to user interface 105 as a list of constructs. Moreover, the top construct may be presented first on a list of constructs. As such, if a user selects that top construct, the elements of the result set are greatly reduced, when compared to the last construct on the list, which is less relevant and thus may not discriminate between elements. The reduced result set S may be further (and/or repeatedly) processed as described above to determine the relevance measure (e.g., with process 292).

The following provides example user interfaces generated by knowledge acquisition engine 150 and provided to user interface 105 for presentation to implement processes 200 and 292.

FIG. 3A depicts a page 305 presented at user interface 105 after, for example, a user is granted access to server 110. Page 305 is generated by server 110 (and, in particular, knowledge acquisition engine 150) and provided to user interface 105. Next, a user may complete one or more fields of page 305 during a repertory interview, as described above with respect to 210. For example, a user may input an element name, such as file format 312A, a description 312B of that element, and define names of instances 312C of that element. A user may select done 310D after entering information 312A-C, at which point the information 312A-C is provided to communication link 155 A, server 110, and knowledge acquisition engine 150. The received information is then provided to repertory grid 160. In a similar manner, a user may provide to system 100 other elements, constructs, and/or rates.

FIG. 3B depicts the element GIF being provided via page 315 at user interface 105. The user inputs a name 322A, a description of the element 322B, instances of the element 322C, and rates 322D. When the information 322A-D is ready to be provided to knowledge acquisition engine 150 and repertory grid 160, the user may select done 322E. Although the pages 305 and 315 depict that a user types in the inputs, other mechanisms may be used, such as drop down boxes, check boxes, and the like.

In some implementations, once there are at least three elements provided by a user and stored in repertory grid 160, knowledge acquisition engine 150 begins a repertory interview process, as described above at 220.

FIGS. 4A-C depict pages 405A, 410A, and 425A generated by knowledge acquisition engine 110 and sent to user interface 105 for presentation. For example, after 3 elements are provided, knowledge acquisition engine 150 may initiate (or, alternatively a user may initiate) the repertory interview by providing page 405A to user interface 105. Page 405A includes information 405B to guide a user at user interface 105 through the repertory interview process. At 405C, a selection is made to pick two elements (e.g., BMP and JPEG) that have a similar construct. Page 405A also allows the user to select stop 405C or continue 405B with the repertory interview.

FIG. 4B depicts page 410A, which may be presented at user interface 105 after page 405A. The knowledge acquisition engine 150 continues to guide the user through the repertory interview by prompting the user to explain why BMP and JPEG are similar constructs 410B. In addition, at 410C, the construct “is good for photos” is input.

FIG. 4C depicts page 425A, which may be presented at user interface 105 after page 405A. The knowledge acquisition engine 150 continues to guide the user through the repertory interview by prompting the user at 425B to explain why the third element of the triad GIF is different from BMP and JPEG. At 425C, this difference is captured as a construct “is good for cartoons and drawings,” or as the construct 425D “is good on photos.” The user is able start over and repeat the process by selecting 425E, which results in a page similar to page 405A being presented.

FIG. 5 depicts a page 505 generated by knowledge acquisition engine 150 and provided to user interface 105 for presentation. User interface presents page 505, which includes information about a construct to allow a user at user interface 105 to change aspects of the elements, constructs, or rates. At 510A, user interface 105 is configured to allow a selection between types of constructs, such as a binary construct type and a 5-point construct type (both of which are described above). At 510B, user interface 105 is configured to invert poles (e.g., the rating 5 is swapped with 1, so that 5 means is good on cartoons and drawings and 1 means is good on photos). At 510C, user interface 105 is configured to allow corrections to phrases used to designate each pole of the construct. At 510D, user interface 105 is configured to allow changes to the general description for the construct. At 510E, user interface 105 is configured to allow changes to rates associated with each element by clicking the appropriate box (e.g., checked boxes are shown with an X). For example, BMP has a checked box for “is good on photos.” At 510F, user interface 105 is configured to indicate that changes to the construct are complete and can be used in repertory grid 160. Page 505 may be presented in connection with a given construct and any set of elements (e.g., a triad, all elements rated against a given construct, etc.).

FIG. 6 depicts a page 605 generated by knowledge acquisition engine 150 and sent to user interface 105 for presentation. User interface presents page 605, which includes information about a construct to allow a user at user interface 105 to change aspects of the elements, constructs, or rates. Page 605 is similar to page 505 but includes a 5-point construct type at 610B. At 610A, page 605 includes information about the new construct (e.g., changing to a 5-point scale for the construct), which allows a user to change characteristics or how the various elements are rated against this particular construct. At 610B, user interface 105 is configured to select a 5-point construct type. At 610C, user interface 105 is configured to invert poles, as described above. At 610D, user interface 105 is configured allow changes to the ratings for the element BMP. At 610E, user interface 105 is configured to allow changes to the description of the construct. At 610F, user interface 105 is configured to allow changes to the ratings (e.g., BMP may be changed to the “is neutral” construct). When a user selects done 610G, the information at page 605 is sent to server 110 and knowledge acquisition engine 150, so that the received information can be stored in repertory grid 160. Page 605 may be presented in connection with a single construct and any combination of elements (e.g., a triad, all elements rated against a given construct, etc.).

The information provided by a user at user interface 105 and received at server 110 and knowledge acquisition engine 150 is used to configure repertory grid 160. Once the interview phase at 210 is complete (or at least in a state where searches of repertory grid 160 may be performed), server 160 and/or keyword-based searcher 154 may generate page 705 to allow a text search of repertory grid 160. The keyword for the keyword-based search is entered at 710. The keyword is provided to server 110 and keyword-based searcher 154 to perform a search of repertory grid 160, which may result in a match to the keyword. For example, keyword-based searcher 154 may search the descriptions of the elements of repertory grid for the term “Microsoft.” Any result is isolated in a result set and provided to user interface 105 for presentation.

The following describes an example implementation of CSR 152 configured to perform a criteria-based search of repertory grid 160 with ranking (e.g., ranking based on the relevance measure described above).

As noted above, during the processing of repertory grid 160, CSR 152 may evaluate all constructs that are applicable to all elements in set S by discarding all constructs of repertory grid 160 that are not relevant (e.g., with a zero rating) to one or more elements of repertory grid 160. Moreover, all constructs with ratings that are constant (e.g., all of the ratings of the construct are equal to 5) are discarded. Table 7 depicts the repertory grid of Table 2 (excluding the file formats element) after discards, which are not applicable and are constant. The set of resulting constructs is referred to as C. In some implementations, CSR 152 makes a copy of repertory grid, which is used to perform the processing described herein. Moreover, the repertory grid 160 may be manipulated as matrix, such as a sparse matrix.

TABLE 7
RESULTING CONSTRUCTS AFTER DISCARDS

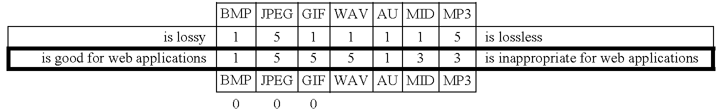

Referring to Table 7, CSR 152 uses the ratings to determine a relevance measure. For example, for row one of Table 7 (i.e., is lossy), CSR 152 determines that 2 elements have ratings of 5 and 5 elements have ratings of 1. Therefore, the largest group of elements is 5. For row 2, 3 elements have ratings of 5, 2 elements have ratings of 3, and 2 elements have ratings of 1. CSR 52 may thus determine that row 2 (“is good for web applications” “is inappropriate for web applications) since 3 is less than 5, the CSR 152 selects the second row.

Continuing with the previous example, CSR 152 may generate page 805, which is depicted at FIG. 8, for presentation at user interface 105. As noted, in this example, CSR selects row 2 from Table 7 (“is good for web applications” “in inappropriate for web applications) and uses that row as the criteria 810A at page 805. Moreover, the criteria 810A includes ratings (e.g., 1, 3, and 5) and a corresponding construct description 810B. In this example, a user at user interface 105 may select a value (or range of values) for the rating 810C or ignore the construct by selecting do not care 810D. A user at user interface 105 may skip the current construct and select one of the other constructs, as depicted at 810E. Moreover, the user may stop the search by selecting show results 810F. Given that the user selects rating 5, which “is good for web applications,” CSR 152 selects all elements (e.g., columns) from the repertory grid 160 matrix that have a rating of 5 for “is good for web applications” and all other columns are ignored (or discarded), which is depicted below at Table 8. Referring to Table 8, the criteria-based search would result in three elements (e.g., JPEG, GIF, and WAV) being provided (e.g., as a page) to user interface 105. The dashed lines at Table 8 represent discarded elements.

TABLE 8
CRITERIA-BASED SEARCH OF REPERTORY GRID

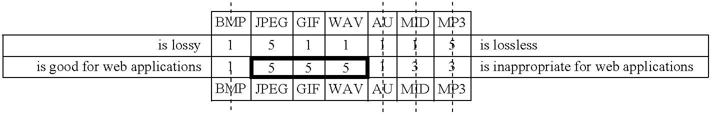

CSR 152 then returns to the original repertory grid and selects columns for the elements, which were just identified by a search (e.g., JPEG, GIF, and WAV). CSR 152 then discards rows that have the same value (e.g., rows 1 and 5) or have at least one zero (e.g., rows 4, 6, 7, and 8). Table 9 depicts this discard of rows and Table 10 depicts the result. The dashed lines at Table 9 represent discarded constructs.

TABLE 9
REPERTORY GRID DEPICTING DISCARDS

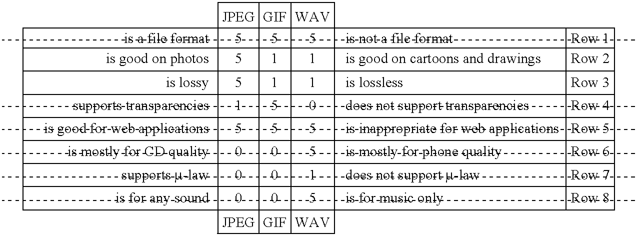

Referring to Table 10, row 2 (“is good on photos”), which was not included in Table 9, is now included in Table 10. CSR 152 may repeat the above-described process. In the example of Table 10, CSR 152 may select the construct at either row because these rows both have the same relevance measure (as both rows have the same rating values).

TABLE 10
REPERTORY GRID AFTER DISCARDS

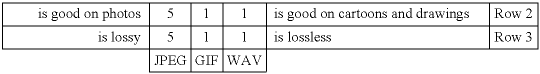

Given that row 3 is selected, CSR 152 (or knowledge acquisition engine 150) provides a question, which is presented as page 905 at FIG. 9. In the example of page 905, the construct type is binary, so CSR 152 includes only two poles. If the user does not understand the question(s), the user may select do not care at 910A. The technical level of an expert (which provided the data of repertory grid 160) may be well beyond the level of the user searching grid 160. Nonetheless, this case does not prevent CSR 152 progressing through the search (giving the “don't care” as a way for the user to opt out if the question is beyond a user's understanding). The user may also skip this “is lossy construct” by selecting another construct at 910B.

Given the user skips the construct “is lossy” and selects, at 910B, the construct “is good on photos,” CSR 152 provides page 1000 for presentation at user interface 105, as depicted at FIG. 10. Continuing with the previous example, supposing the user just wanted something appropriate for a web application and something that deals with cartoons and drawings, like viewgraphs. The user may use user interface 105 to select construct “is good in cartoons and drawings” at 1010A. The resulting elements are WAV and GIF are selected, which are depicted at row 2 of Table 10. CSR 152 may then return to the repertory grid and select the columns corresponding to elements GIF and WAV, discard all rows having the same value, and discard all rows with at least one zero entry. Moreover, any rows for which a construct has already been applied (e.g., at row 3 “is lossless” “is lossy”) is discarded. Table 11 depicts the resulting repertory grid with the dashed lines representing the discards. As can be seen from Table 11, there are no constructs remaining, so the process stops, and the CSR 152 provides the result set.

TABLE 11
REPERTORY GRID AFTER DISCARDS

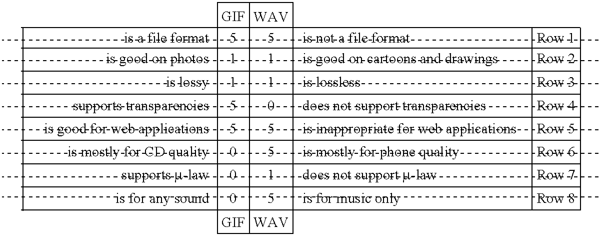

FIG. 11 depicts a page 1105 including the results for the example of Table 11. Since there is more than one element in the result set, system 100 may offer a keyword-based search 1110A for the word “audio.” At any point, when a keyword-based or a criteria-based search terminates (e.g., on a user request or when the system had found all matching results) and more than one element is found, the system 100 may offer a subsequent keyword-based search to refine the search results. In addition, if there any applicable constructs (e.g., rows of a table that have different values and none of those row values are zero), the system 100 may offer a criteria-based search.

In some implementations of system 100, providing a combination of keyword and criteria based searches allows a user to narrow down on a target search result from a textual and a semantic perspective. To illustrate the point, FIG. 12 depicts a page 1205 used to provide keywords to keyword searcher 154. In this example, the term “Microsoft” 1210A is the keyword being search at repertory grid 160. In this example, only the columns for elements BMP and WAV 1210B are identified by keyword searcher 154 since those terms include the term Microsoft in the description of the elements.

Next, system 100 may be used to perform a criteria-based search. When this is the case, CSR 152 may discard from the repertory grid 160 all rows that have identical entries (e.g., rows 1 and 3) and discard rows having at least one zero (e.g., rows 4, 6, 7, and 8). At this point, repertory grid includes only row 2 and row 5 (e.g., row 2 “is good on photos—is neutral—is good on cartoons and drawings” and row 5 “is good for web applications—is possible to use in a web application—is inappropriate for web applications”). Using the corresponding constructs, the system 100 may further reduce the elements to distinguish between the remaining elements of the result sets using the above-described processes.

If a search is terminated with more than one element in the result set, knowledge acquisition engine 150 may typically generate a page, such as page 1305 depicted at FIG. 13, although page 1305 may be generated at anytime as well. In some implementations, a selection is made (e.g., by selecting 1210C at FIG. 12) to generate the page 1305 using data from the repertory grid 160.

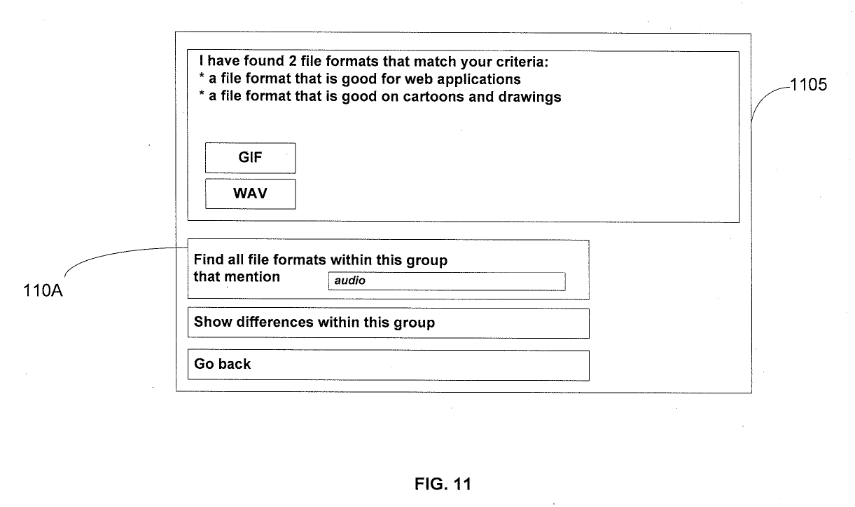

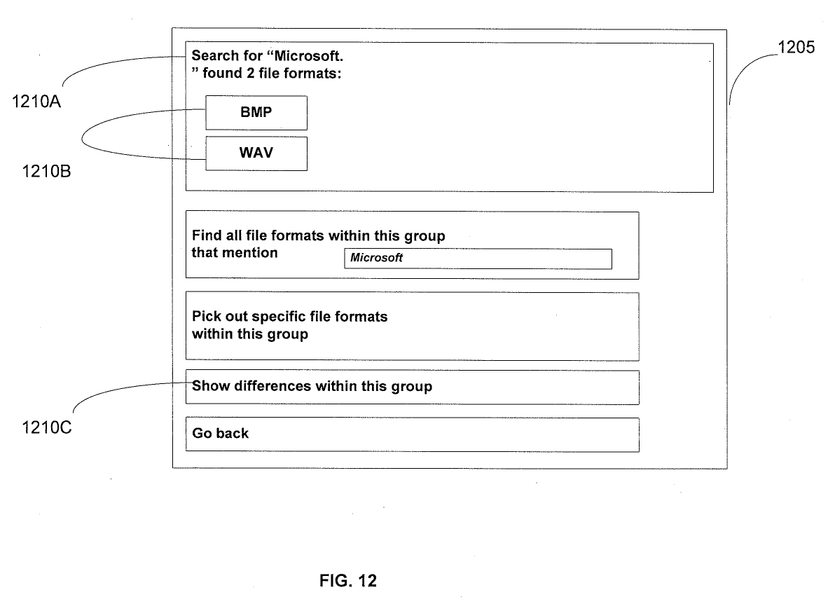

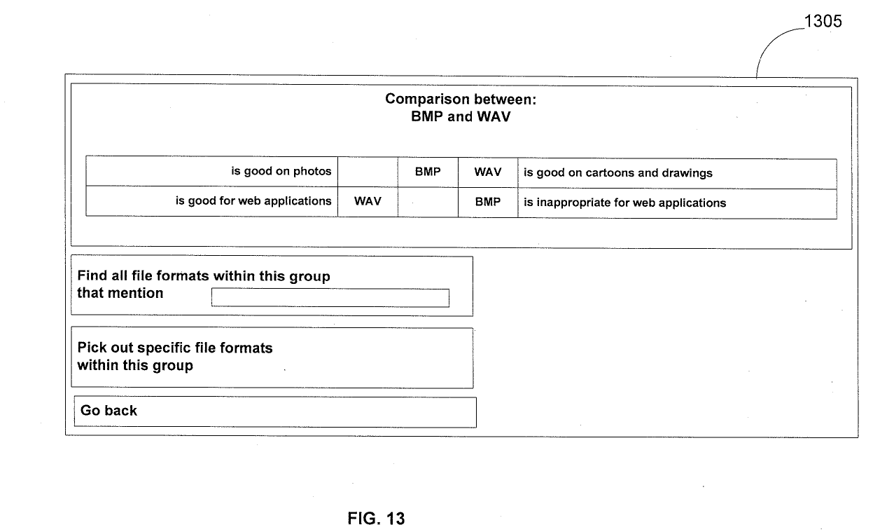

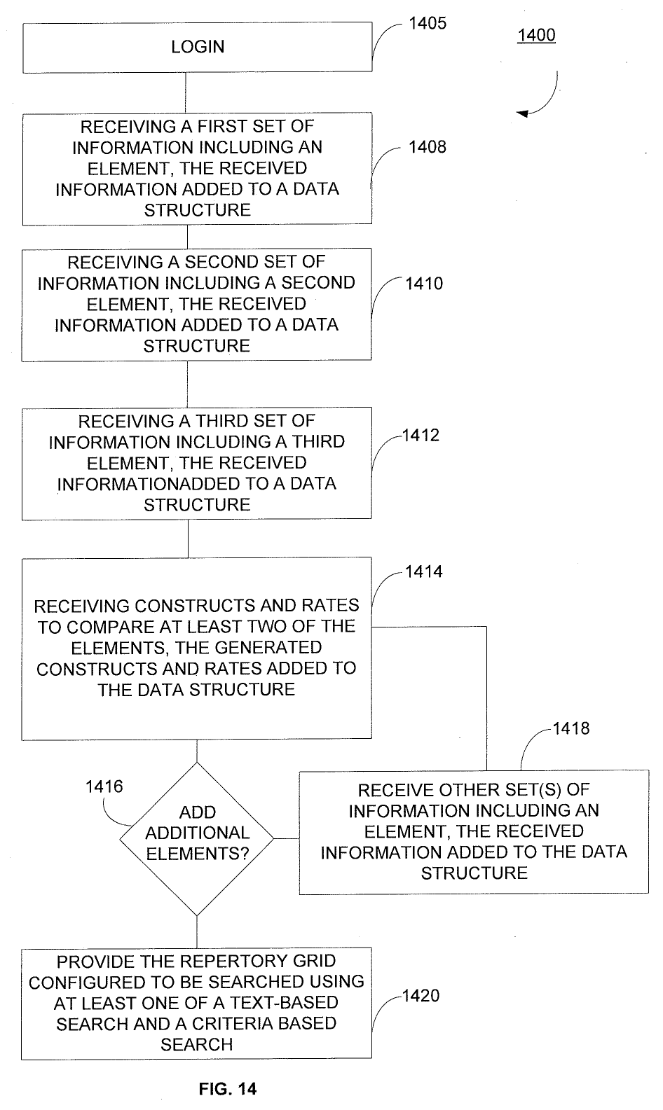

FIG. 14 depicts a process 1400 for generating data, as described above with respect to 220 and FIGS. 3A-B, 4A-C, 5, and 6. The generated data is used to configure repertory grid 160.

At 1405, a user at user interface 105 accesses server 110 to login to the server 110 (which may include a login into knowledge acquisition engine 150). The login may include providing a user name and a password.

At 1408, knowledge acquisition engine 150 may receive a first set of information from a user interface 105. The first set of information may include an element. Knowledge acquisition engine 150 may store the received information in repertory grid 160.

At 1410, knowledge acquisition engine 150 may receive a second set of information from user interface 105. The second set of information may include another element. Knowledge acquisition engine 150 may store this received information in repertory grid 160.

At 1412, knowledge acquisition engine 150 may receive a third set of information from user interface 105. The third set of information may include yet another element. Knowledge acquisition engine 150 may store this received information in repertory grid 160.

At 1414, knowledge acquisition engine 150 may then initiate a repertory interview process to obtain constructs and rating values for the constructs. In some implementations, the knowledge acquisition engine 150 generates pages (e.g., pages 305, 315, 405A, 410A, 425A, 505, and 605) to guide a user at user interface 105 through the repertory interview process (e.g., as described above at 210). Moreover, the repertory interview may be guided using a triad approach, in which two elements are compared at any given time to obtain constructs and ratings described above. Moreover, the ratings may include the above described predetermined value (e.g., a zero (0) rating, a blank value, and the like) to allow elements of different domains to be included in the same repertory grid 160. The received constructs and ratings may then be stored in repertory grid 160.

At 1416, additional elements may be added to repertory grid 160. For example, pages 305 and 315 may be presented at user interface 105 to allow a user to input additional elements. At 1418, any additional elements are added to the repertory grid 160. Moreover, constructs and elements for the additional elements may be received by knowledge acquisition engine 150, as described above at 1414.

At 1420, the repertory grid 160 is provided by knowledge acquisition engine 150 to enable searches of grid 160. For example, repertory grid 160 is provided as a structured database, which can be search using a keyword-based search or a criteria-based search. In some implementations, the searching is performed on an index of the repertory grid rather than directly on the grid 160 itself.

Although the above description refers to the data gathering phase driven by the server, the data gathering may be performed offline, with the results entered into a data file, which can be processed and searched as described above. For example, the results of one or more interviews may be processed at 200 as a batch file to generate or add to a data structure, such as grid 160, and then searched using 220.

The subject matter described herein may be embodied in systems, apparatus, methods, and/or articles depending on the desired configuration. In particular, various implementations of the subject matter described herein (including processes 200, 292, and 1400, as well as server 110, knowledge acquisition engine 150, CSR 152, and keyword-based searcher 154, and the like) may be realized in digital electronic circuitry, integrated circuitry, specially designed ASICs (application specific integrated circuits), computer hardware, firmware, software, and/or combinations thereof. However, in a typical implementation, knowledge acquisition engine 150, CSR 152, and keyword-based searcher 154 are implemented as computer programs. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Wherever possible, the same reference numbers will be used throughout the drawings to refer to the same or like parts.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flows depicted in the accompanying figures and/or described herein do not require the particular order shown, or sequential order, to achieve desirable results. Other embodiments may be within the scope of the following claims.

As used herein, the term “user” may refer to any entity including a person or a computer. As used herein a “set” can refer to zero or more items. The relevance and sensitivity measurements may be used interchangeable since both terms refer to the importance of an item to a search. As such, the phrase “relevance measurement” encompasses “sensitivity measurement,” and the phrase “sensitivity measurement,” encompasses the phrase “relevance measurement.”

The foregoing description is intended to illustrate but not to limit the scope of the invention, which is defined by the scope of the appended claims. Other embodiments are within the scope of the following claims.

What is claimed:

1. A computer-readable medium containing instructions to configure a processor to perform a method, the method comprising:
generating a data structure comprising elements, constructs, and rates, the constructs representing characteristics of the elements, and the rates representing the relevance of the constructs with respect to the elements, at least one of the rates representing that a construct is not relevant to an element; and
searching the generated data structure.

2. The computer-readable medium of claim 1, wherein searching further comprises:
searching the generated data structure using a criteria-based search.

3. The computer-readable medium of claim 1, wherein searching further comprises:
searching the generated data structure using a criteria-based search, wherein a result set of the criteria-based search is ranked based on a relevance measurement.

4. The computer-readable medium of claim 1, wherein the data structure is a repertory grid, the repertory grid including at least two elements from different domains and the construct with a rating of zero to indicate that the construct is not relevant to the element.

5. The computer-readable medium of claim 1, wherein at least one of the rates has a predetermined value to represent that the construct is not relevant to the element.

6. The computer-readable medium of claim 1, wherein the data structure is a sparse matrix.

7. A computer-implemented method comprising:
generating a data structure comprising elements, constructs, and rates, the constructs representing characteristics of the elements, and the rates representing the relevance of the constructs with respect to the elements, at least one of the rates representing that a construct is not relevant to an element; and
searching the generated data structure.

8. The method of claim 7, wherein searching further comprises:
searching the generated data structure using a criteria-based search.

9. The method of claim 7, wherein searching further comprises:
searching the generated data structure using a criteria-based search, wherein a result set of the criteria-based search is ranked based on a relevance measurement.

10. The method of claim 7, wherein the data structure is a repertory grid, the repertory grid including at least two elements from different domains and the construct with a rating of zero to indicate that the construct is not relevant to the element.

11. The method of claim 7, wherein at least one of the rates has a predetermined value to represent that the one construct is not relevant to the one element.

12. The method of claim 7, wherein the data structure is a sparse matrix.

13. A system comprising:
a processor; and
a memory, the processor and memory configured to provide a method comprising:
generating a data structure comprising elements, constructs, and rates, the constructs representing characteristics of the elements, and the rates representing the relevance of the constructs with respect to the elements, at least one of the rates representing that a construct is not relevant to an element; and
searching the generated data structure.

14. The system of claim 13 wherein searching further comprises:
searching the generated data structure using a criteria-based search.

15. The system of claim 13, wherein searching further comprises:
searching the generated data structure using a criteria-based search, wherein a result set of the criteria-based search is ranked based on a relevance measurement.

16. The system of claim 13, wherein the data structure is a repertory grid, the repertory grid including at least two elements from different domains and the construct with a rating of zero to indicate that the construct is not relevant to the element.

17. The system of claim 13, wherein at least one of the rates has a predetermined value to represent that the one construct is not relevant to the one element.

18. The system of claim 13, wherein the data structure is a sparse matrix.
